(19) United States
(12) Patent Application Publication
(10) Pub. No.: US 2009/0247655 A1
(43) Pub. Date: Oct. 1, 2009

(54) METHOD FOR PREPARING PERMANENTLY HYDROPHOBIC AEROGEL AND PERMANENTLY HYDROPHOBIC AEROGEL PREPARED BY USING THE METHOD

(75) Inventors: Gyung-Soo Kim, Gyeonggi-do (KR); Hyun-Aee Chun, Gyeonggi-do (KR); Hyun-Chul Choi, Choogcheongnam-do (KR); Young-Jung Kim, Gangwon-do (KR)

Correspondence Address: IPHORGAN, LTD., 1130 LAKE COOK ROAD, SUITE 240, BUFFALO GROVE, IL, 60089, US

(73) Assignee: KOREA INSTITUTE OF INDUSTRIAL TECHNOLOGY, Choogcheongnam-do (KR)

(21) Appl. No.: 12/304,130

(22) PCT Filed: Oct. 10, 2007
(86) PCT No.: PCT/KR2007/004944

§ 371 Date: Jan. 30, 2009

(30) Foreign Application Priority Data
Oct. 10, 2006 (KR) 10-2006-0098634
May 9, 2007 (KR) 10-2007-0045207

(51) Int. Cl. C08J 9/28

(52) U.S. Cl. 521/64

(57) ABSTRACT

A method for preparing permanently hydrophobic aerogel and permanently hydrophobic aerogel prepared by the method. The method comprises adding sodium silicate to HCl at 30 to 90° C. until an acidity reaches pH 3-5, to form silica hydrogel under acidic conditions of pH 3-5, washing the silica hydrogel with distilled water using a mixer, followed by filtering, adding the silica hydrogel to a silylating solution of silylating agent in n-butanol at pH 1-5 using an acid selected from hydrochloric acid, sulfuric acid, phosphoric acid and nitric acid, to simultaneously conduct silylation and solvent replacement, and drying the silica hydrogel; The method has the following advantages; i) silylation and solvent replacement can be simultaneously conducted, ii) n-butanol is used as a reaction solvent instead of methanol upon silylation, thus obtaining a thermal conductivity comparable to conventional aerogel powders, iii) silylation is conducted under improved conditions, i.e., strong acidic conditions of pH 1-5, and as a result, all of the aerogel powders can be reacted with a silylating agent, thereby obtaining permanently hydrophobic aerogel, iv) the washing with a mixer makes the amount of removed sodium ions uniform, thus it is suitable for mass-production, and v) the method provides a relatively simplified procedure and the use of the silylating agent in a small amount enables low costs and mass-production.

### TECHNICAL FIELD

The present invention relates to a method for preparing permanently hydrophobic aerogel and permanently hydrophobic aerogel prepared by the method. More specifically, the present invention relates to a method for preparing permanently hydrophobic aerogel that can achieve low-cost and mass-production by simultaneous treatment of silylation and solvent replacement under strongly acidic conditions, and permanently hydrophobic aerogel prepared by the method.

### BACKGROUND ART

With recent trends toward high-technology, aerogels have increasingly attracted considerable attention. Aerogelsare a transparent advanced-material that has a porosity of 90% or more, a specific surface area of hundreds to 1500 m²/g and an ultra-low density. Thus, porous aerogels are widely applied to fields including ultra-low dielectrics, catalysts, electrode materials and soundproof materials. In particular, since silica aerogels have a high transmittance and a low thermal conductivity, they have great potential use in transparent insulating materials. In addition, silica aerogels are efficiently used as superinsulating materials for refrigerators, automobiles and aircrafts etc.

Various methods for preparing aerogel have been proposed. For example, WO 95/06617 discloses a method for preparing hydrophobic silica aerogel. In accordance with the method, water glass is reacted with sulfuric acid, etc., at a pH of 7.5 to 111 to form silica hydrogel. The silica hydrogel is washed with water or a diluted aqueous solution of inorganic bases (e.g., a diluted sodium hydroxide aqueous solution or diluted ammonia aqueous solution) at a pH of 7.5 to 11 to remove ions therefrom, followed by removing water contained in the hydrogel with C₁-C₅ alcohol. The resulting hydrogel is dried under supercritical conditions, i.e., at a temperature of 240 to 280° C. and a pressure of 55 to 90 bar, to prepare hydrophobic silica aerogel. This method involves supercritical drying without any silylation.

WO 96/22942 discloses a method for preparing aerogel. In accordance with the method, silicate lyogel is produced. Then, the lyogel are subjected to solvent replacement with another solvent (e.g., methanol, ethanol, propanol, acetone and tetrahydrofuran), if necessary. The resulting lyogel is reacted with at least one chlorine-free silylating agent, and the resulting lyogel is subjected to supercritical drying, thereby preparing aerogel. This method involves solvent replacement prior to silylation, and subsequently supercritical drying.

WO 98/23367 discloses a method for preparing aerogel. In accordance with the method, water glass is reacted with an add to form lyogel. The lyogel is washed with an organic solvent (e.g., alcohol including methanol and ethanol, and ketone including acetone), followed by silylation and drying, to prepare aerogels. This method involves solvent replacement prior to silylation.

WO 97/17288 discloses a method for preparing aerogel. In the method, silicic acid sol (pH≦4.0) is prepared from a water glass aqueous solution with the aid of organic and/or inorganic acid. A salt formed from the acid and the cations of the water glass is separated from the silicic acid sol at 0 to 30° C. A base is added to the silicic acid sol to polycondense SiO₂ gel. The resulting gel is washed with an organic solvent (e.g., aliphatic alcohols, ethers, esters, ketones, aliphatic or aromatic hydrocarbons) until the water content obtained therein is equal to or less than 5% by weight, followed by silylation and drying, to prepare aerogel. This method also involves solvent replacement prior to silylation.

WO 97/13721 discloses a method for preparing aerogel. In the method, water contained in hydrogel particles is replaced by an organic solvent such as C₁-C₆ aliphatic alcohol. The organic solvent is removed from the hydrogel particles by using another solvent such as C₁-C₃ alcohol, diethyl ether, acetone, n-pentane or n-hexane. The resulting hydrogel particles are dried at a temperature of boiling point of the solvent or more at ambient pressure to lower than the pyrolysis temperature of the solvent, and at a pressure less than the supercritical pressure of the solvent. This method is associated with ambient pressure drying without using any silylation. The ambient pressure drying is carried out by two-step solvent replacement including first-replacing water by a polar solvent (e.g., butanol) and second-replacing the polar solvent by a non-polar solvent (e.g., pentane) for ambient pressure drying. As a result, this method has a problem of being a complicated procedure.

WO 98/23366 discloses a method for preparing aerogel. The method comprises the steps of forming hydrogels at a pH equal to or greater than 3, conducting intermediate processes, mixing hydrogel with a hydrophobic agent to obtain surface-modified hydrogel, washing the hydrogel with a protic or aprotic solvent (e.g., aliphatic alcohols, ethers, esters, ketones, aliphatic or aromatic hydrocarbons), or a silylating agent, followed by drying. Replacement of water by another solvent causes a waste of time and energy. In this method, aerogel can be prepared without conducting solvent replacement.

Meanwhile, Korean Patent Application No. 10-2004-0072145 discloses removing water contained in silica by using a solvent (e.g., n-butanol, n-propanol or a mixture thereof) in preparation of nanocrystalline silica. The water removal will be explained in detail as follows. First, HCl is added to sodium silicate for enhancement in reaction rate to precipitate silica. The precipitated silica is mixed with the solvent (e.g., butanol), followed by filtering and distilling, to remove moisture contained therein. The resulting silica is dried at a high temperature of 285° C. to prepare nanocrystalline silica. During solvent replacement and subsequent drying, a hydroxyl group (—OH) present on the surface of silica is reacted with butanol and replaced with a butoxy group, which is demonstrated in Reaction 1 below.

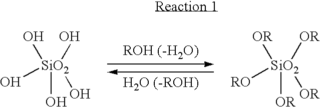

As a result, the silica surface may be provided with hydrophobicity. However, the silica is reacted with moisture in air, which may cause an inverse reaction. In this case, the butoxy group is converted into a hydrophilic group, thus making it impossible to ensure permanent hydrophobicity of silica.

Korean Application No. 10-2006-0087884 filed by the present applicant in attempts to solve the problems, entitled “A method for preparing surface-modified aerogel and surface-modified aerogel prepared by using the method” discloses a method for preparing hydrophobical surface-modified aerogel with a silane compound. However, the method involves several problems in practical use. Firstly, silylation and solvent replacement are independently conducted, thus causing a disadvantage in a continuous process. Secondly, since reaction is performed at the presence of an alcohol (e.g., methanol) upon silylation, alcohol (methanol) exists in aerogel, thus leading to an increase in thermal conductivity (See FIG. 3). Thirdly, washed hydrogel is a weak acid (pH=6). When the silylation is conducted under the pH condition, unmodified powder remains on the surface, thus causing deterioration in hydrophobicity. Fourthly, the silylating agent is used in a great amount, thus causing a disadvantage in production costs. Fifthly, distilled water only is used for removal of Na+ ion upon washing. Accordingly, the amount of the removed Na+ ion is non-uniform, thus making it impossible to realize mass-production.

However, hydrophobic aerogel prepared by the conventional methods has a disadvantage of difficulty of handling upon subsequent processing because of its low density of 0.02 g/cc and small particle size. For example, to utilize aerogel in heat insulating materials, etc., aerogel particles must be mixed with a binder in a solvent.

But, due to the very low density of aerogel, phase-separation takes place between the aerogel particles and the solvent, thus making it difficult to mix the two phases. In addition, the aerogel having the low density and very small particle size is scattered and the composition ratio is thus varied. Furthermore, since the aerogel has excessively light weight, it causes inconvenience for applying to a production process e.g., incomplete feeding into processing instruments.

There have been suggested several techniques for controlling the particle size of aerogel. For example, U.S. Pat. Nos. 6,620,355 and 6,481,649 disclose a method for compacting aerogel particles comprising molding aerogel particles in a molding apparatus or roller wherein the aerogel particles are degassed prior to and/or during molding. According to the method, if necessary, fillers and binders are used to compact the aerogel particles. However, the performance of the compacting only of aerogel particles makes it impossible to obtain aerogel granules, and in practice, use of binders is inevitable. The use of binders disadvantageously involves an increase of the thermal conductivity of aerogel and deterioration in insulating capability of the aerogel.

Accordingly, to commercialize aerogel as one of the most advanced materials, there is a need for aerogel that is permanently hydrophobic and has an increased density and diameter.

### DISCLOSURE OF INVENTION

### Technical Problem

In attempts to solve the problems of the prior art, it is one object of the present invention to provide a method for preparing surface-modified aerogel having permanent hydrophobicity under ambient pressure conditions at low costs.

It is another object of the present invention to provide a method for preparing surface-modified aerogel with permanent hydrophobicity which can achieve low-cost mass-production by a consecutive process.

It is another object of the present invention to provide a method for preparing surface-modified aerogel which is permanently hydrophobic and has an increased diameter.

It is another object of the present invention to provide permanently hydrophobic aerogel prepared by the method.

It is yet another object of the present invention to provide surface-modified aerogel which has an increased diameter and is permanently hydrophobic.

### Technical Solution

In accordance with one aspect of the present invention, there is provided a method for preparing permanently hydrophobic aerogel comprising: adding sodium silicate to HCl at 30 to 90° C. until an acidity reaches pH 3-5, to form silica hydrogel under acidic conditions of pH 3-5; washing the silica hydrogel with distilled water using a mixer, followed by filtering; adding the silica hydrogel to silylating solution of silylating agent in n-butanol at pH 1-5 using an acid selected from hydrochloric acid, sulfuric acid, phosphoric acid and nitric acid, to simultaneously conduct silylation and solvent replacement; and drying the silica hydrogel.

In accordance with another aspect of the present invention, there is provided permanently hydrophobic aerogel prepared by the method.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a flow chart illustrating a method for preparing permanently hydrophobic aerogel according to one embodiment of the present invention;

FIG. 2 is a flow chart illustrating a method for preparing permanently hydrophobic aerogel with an increased diameter according to yet another embodiment of the present invention;

FIG. 3 is a thermal gravimetric analysis (TGA) graph illustrating variations in the content of the remaining solvent in an aerogel powder prepared according to the present invention (Example 2) and an aerogel powder prepared by silylation with a silylating solution of a silylating agent in methanol according to a conventional method (Comparative Example 2-3);

FIG. 4 is a photograph confirming whether or not aerogels prepared in Example 2 and Comparative Example 2-4 are hydrophobically surface-modified;

FIG. 5 is a graph showing distribution for the particle size of aerogels prepared in Examples 2, 6 and 7 according to the present invention;

FIG. 6 is a graph showing distribution for the particle size of aerogels prepared in Examples 2 and 8 according to the present invention; and

FIG. 7 is a graph showing the variation of thermal conductivity of aerogels prepared in example 2 based on the elapsed time.

### BEST MODE FOR CARRYING OUT THE INVENTION

The present invention will now be described in greater detail.

The present invention provides a one-step procedure of silylation and solvent replacement, which is suitable for use in a continuous process. In accordance with the present invention, n-butanol is used as a process solvent, instead of methanol, thus ensuring efficient removal of the residual solvent as well as drying of hydrogel. As a result, aerogel powder of the present invention can achieve a thermal conductivity comparable to conventional aerogel powders, preferably improved insulation property. Silylation of washed aerogel is conducted under improved conditions, i.e., strong acid conditions of pH 1 to 5. As a result, all of the aerogel powder can be reacted with a silylating agent without leaving any residue behind, thereby obtaining permanently hydrophobic aerogel. The amount of sodium ions (Na+ ions), which is removed from the hydrogel by washing with a mixer, is uniformly maintained. In addition, the silylating agent is used in a small amount, thus make it possible to achieve cost effective mass-production. In addition, if necessary, by adding seed particles, aerogel with an increased diameter can be prepared.

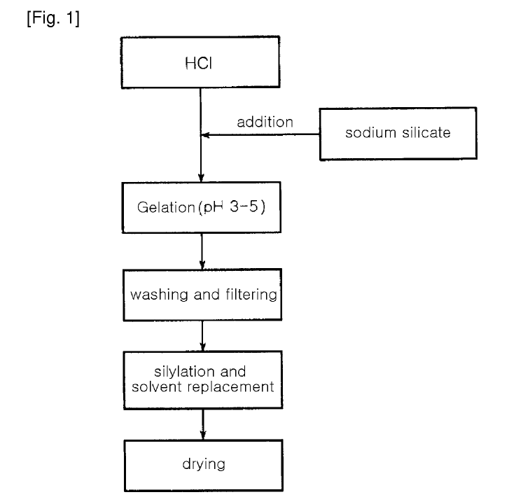

FIG. 1 is a method for preparing surface-modified hydrophobic aerogel according to the present invention. As shown in FIG. 1, sodium silicate (also known as “water glass” is added to HCl at a temperature of 30 to 90° C. until acidity reaches pH 3 to 5, to form silica hydrogel. When pH of a reaction medium is less than 3 or greater than 5, a reaction rate is too high or low to efficiently control the formation of silica hydrogel. Thus, pH out of the range defined above is undesirable in view of production and economical efficiency of silica hydrogel. The reaction is carried out at 30 to 90° C., preferably, at 40 to 70° C. The temperature lower than 30° C. leads to a long reaction time. The temperature exceeding 90° C. makes it difficult to control the structure of silica hydrogel. Accordingly, temperature out of the range defined above is undesirable.

If necessary, upon the formation of silica hydrogel, with the addition of seed particles, aerogel with an increased diameter can be prepared.

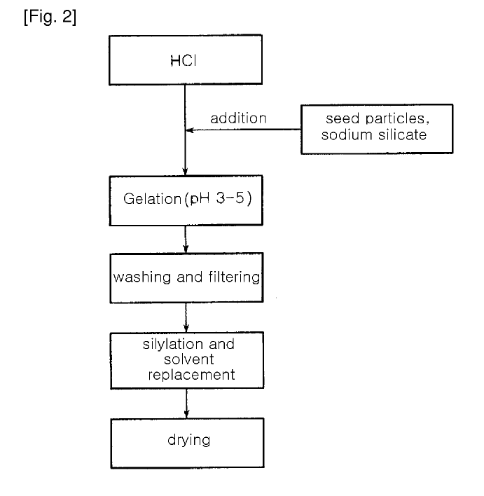

FIG. 2 shows a method for preparing permanently hydrophobic aerogel with an increased diameter according to another embodiment of the present invention. Namely, the permanently hydrophobic aerogel with an increased diameter can be prepared by separately adding seed particles during formation of silica hydrogel, as shown in FIG. 2. Specifically, aerogel particles are clustered around the seed particles added, and at the same time, are sol-gelized. As a result, a larger-diameter aerogel can be obtained.

Seed particles that may be used in the present invention may be at least one selected from the group consisting of fumed silica, TiO₂, Fe₂O₃ and Al₂O₃. Preferred is the use of fumed silica, taking into consideration the fact that fumed silica is composed of the same SiO₂ molecules as aerogel, and exhibits superior adhesivity to the surface of aerogel, as compared to other seed particles. The seed particles are preferably added in an amount of 0.5 to 20% by weight, based on the weight of sodium silicate. The content of the seed particles less than 0.5 wt % is undesirable, because seed particles formed in a solution are insufficient. Meanwhile, the content of the seed particles exceeding 20 wt % is undesirable in that the number of aerogels adhered to seed particles is small and unexpected bindings between seed particles may occur due to the excessive seed particles. In addition, the seed particles has preferably a size of 0.1 to 500 μm. The seed particles having a size smaller than 0.1 μm are undesirable, because they are excessively light and are thus immiscible with the reaction solution. Meanwhile, the seed particles having a size exceeding 500 μm are undesired, since they are precipitated in the bottom of the reactor due to their large weight and remain unreacted with the reaction solution.

After forming the silica hydrogel as mentioned above, the silica hydrogel is washed with distillated water and followed by filtering, to remove NaCl and impurities contained in the silica hydrogel. The washing has an influence on porosity of the silica hydrogel obtained from drying. That is, when residual impurities (e.g., ion impurities) still remain in the silica hydrogel even after the washing, they cause collapse of the gel structure during drying, thus resulting in damage to porosity of the silica hydrogel. In addition, ion impurities induce a decrease in hydrophobicity of dried aerogel. Accordingly, the amount of sodium ions is uniformly maintained by washing with a mixer, thereby realizing mass-production of aerogel.

If necessary, aging is performed prior to the washing and filtering after silica hydrogel formation, thus enabling formation of fine particulate silica hydrogel. The aging is performed by varying the temperature and time, thereby obtaining desired fine particulate silica hydrogel. For example, the aging is performed around room temperature (e.g., 20 to 25° C.) to 80° C. for about 2 to 24 hours.

After washing and filtering, the surface of the silica hydrogel is silylated to form surface-modified hydrophobic silica hydrogels. At this time, a silane compound is used as a silylating agent, which is represented by Formulas 1 and/or 2 below:

(R₁)₄₋ₙSiXₙ (1)

wherein n is 1 to 3; R₁ is a C₁-C₁₀ alkyl group, preferably, a C₁-C₅ alkyl group, a C₆ aromatic group (wherein the aromatic group can be substituted with C₁-C₂ alkyl group), a C₅ heteroaromatic group (wherein the heteroaromatic group can be substituted with C₁-C₂ alkyl group), or hydrogen; X is a halogen atom selected from F, Cl, Br and I, preferably, Cl, a C₁-C₁₀ alkoxy group, preferably, a C₁-C₅ alkoxy group, a C₆ aromatic group (wherein the aromatic group can be substituted with C₁-C₂ alkoxy group) or C₅ heteroaromatic group (wherein the heteroaromatic group can be substituted with C₁-C₂ alkoxy group); and

R₃Si—O—SiR₃ (2)

wherein, the disiloxane of Formula (2), each R₃ is same or different and a C₁-C₁₀ alkyl group, preferably, a C₁-C₅ alkyl group, a C₆ aromatic group (wherein the aromatic group can be substituted with C₁-C₂ alkyl group), a C₅ heteroaromatic group (wherein the heteroaromatic group can be substituted with C₁-C₂ alkyl group), or hydrogen.

Examples of the silylating agent include at least one selected from the group consisting of hexamethyldisilane, ethyltriethxoysilane, trimethoxysilane, triethylethoxysilane, methyltrimethoxysilane, ethyltrimethoxysilane, methoxytrimethylsilane, trimethylchlorosilane and triethylchlorosilane, but are not limited thereto.

The silylation is simultaneously performed with solvent replacement with a silylating solution of the silylating agent in n-butanol as solvent for the solvent replacement. 1 to 10% by weight of the silylating agent is mixed with 90 to 99% by weight of n-butanol, to prepare a silylating solution (pH=1-4). For example, the silica hydrogel is refluxed in the silylating solution for 2 to 24 hours but is not limited thereto. When the reflux is conducted for 2 hours below, in some cases, it may have hardly enough time to realize complete silylation according to the kind of silylating agent used. Meanwhile, when the reflux is conducted for above 24 hours, an undesired side reaction may occur. Thus, it is preferable to reflux for 2 to 24 hours. Further, it is preferable that the reflux is conducted until no water is discharged together with n-butanol when n-butanol vapor is condensed with a connected condenser. The reflux is conducted at about boiling point of the silylating solution. n-butanol is inflammble and thus it should be handled carefully.

The content of the silylating agent less than 1 wt % is undesirable, since it is not enough to surface-modify all aerogels. Meanwhile, when the content of the silylating agent exceeds 10 wt %, it is undesirable in view of production costs since the silylating agent remains unreacted.

The silylation and solvent-replacement are carried out at pH 1-5. The pH can be adjusted using acid selected from hydrochloric acid, sulfuric acid, phosphoric acid and nitric acid. Since these reactions are carried out under strongly acidic conditions of pH 1-5, all aerogel powders can be reacted with the silylating agent. As a result, aerogel can be permanently hydrophobized. When pH is out of the range, the silylation rate is undesirably low.

In accordance with the silylation, although the silylating agent having a low concentration is used, it is possible to prepare aerogel powder having a comparable property of thermal conductivity. In addition, silylation is conducted under improved conditions, i.e., strong acid conditions. As a result, all of the aerogel powder can be reacted with the silylating agent without leaving any residue behind, thereby obtaining permanently hydrophobic aerogel, which is demonstrated in Reaction 2 below:

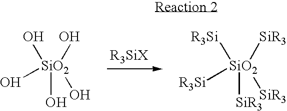

Prior to drying, which is given in the following description, unless the remaining moisture in silica hydrogel is fully removed, a high capillary force of the moisture affects the structure of the gel during the drying and thus causes damage to the porous structure of the gel. As a result, an undesired significant increase in thermal conductivity of the gel occurs. For this reason, in conventional cases, solvent-replacement is separately performed prior to silylation. In contrast, in the method of the present invention, solvent replacement is conducted with n-butanol during silylation, thereby realizing a continuous process and removal of water contained in the silica hydrogel.

In accordance with the present invention, n-butanol is used as a solvent for solvent replacement, because it satisfies the following characteristics required for solvent replacement. Firstly, the solvent for solvent replacement must efficiently remove water in pores of silica hydrogel. To meet the first requirement, the solvent must have a high polarity. Secondly, the solvent must be evaporated while imparting a minimal capillary force to the gel structure during ambient drying. To meet the second requirement, the solvent must have a low surface tension, i.e., low polarity. To satisfy these incompatible requirements, neither a high-polar solvent (e.g., methanol, ethanol, THF (tetrahydrofuran) and acetone) nor a non-polar solvent (e.g., heptane and pentane) can be used. That is, the polar solvent may provide considerably high capillary attraction for the gel structure at an interface between gas and liquid formed during the silica hydrogel drying. Meanwhile, the non-polar solvent is immiscible with water, thus making it impossible to efficiently remove water contained in pores of the silica hydrogel. As a result of repeated studies, the present inventors have found that n-butanol is an optimum solvent which efficiently satisfies the requirements, since it contains both a hydroxyl group (—OH) having polarity and four alkyl groups exhibiting non-polarity. In addition, the n-butanol used in the silylation and solvent-replacement processes is distilled and is then recycled in the processes.

As a final process, water-free surface-modified silica hydrogel obtained from the silylation and solvent replacement is subjected to drying. The drying is preferably performed at a temperature of 100 to 250° C. at ambient pressure. The drying at a temperature lower than 100° C. results in excessively low rate. Meanwhile, when the drying is conducted at a temperature exceeding 250° C., hydrophobized silylated group may get damaged due to thermal decomposition. The drying time is dependant upon factors such as the structure and the particular size of aerogel, the solvent used, and the amount of residual solvent contained in the gel structure. Accordingly, optimum drying time may be determined by measuring with a thermal gravimetric analyzer (TGA) until no residual solvent is detected in dried particles.

According to the present invention, drying is conducted after solvent replacement along with silylation, thereby ensuring permanent maintenance of the structure of aerogel whose surface is hydrophobically modified and a high drying rate. If necessary, aerogel whose surface is hydrophobically modified and whose diameter is increased can be prepared by using seed particles upon the formation of silica hydrogel. Furthermore, the aerogel prepared by method of the present invention has an increased diameter and permanently maintains its hydrophobic structure. The increased diameter of the aerogel involves an increase in density thereof. Such aerogel can be more easily and stably employed in subsequent processes.

### MODE FOR THE INVENTION

The present invention will be better understood from the following examples. These examples are not to be construed as limiting the scope of the invention.

### EXAMPLES

### Example 1

A water glass solution (a 3-fold dilution of a 35 wt % sodium silicate solution in water (i.e. the ratio of a 35% sodium silicate solution and water (1:3, wt/wt)) was slowly added to IL of a 1N hydrochloric acid solution with stirring, to adjust pH of the water glass solution to 3.5. At this time, a reaction temperature was 80° C. The solution was further stirred for about 2 hours, while the pH of 3.5 was maintained, thereby preparing silica hydrogel. The hydrogel was put in a mixer, and was then washed with distilled water several times for 4 hours, to remove Na⁺ ions contained therein. The amount of Na⁺ ions in the washed hydrogel was 2,000 ppm. The resulting silica hydrogel was subjected to solvent displacement to remove water contained therein using solvent such as n-butanol, tert-butanol, propanol, hexane and acetone respectively. The silica hydrogel was immersed in the each solvent and refluxed at 120 to 150° C. for 4 hours. The resulting silica hydrogel was dried at 150° C. for 2 hours to remove the solvent from the surface thereof. The thermal conductivity of each aerogel prepared is measured immediately after obtaining the aerogel and shown in the table 1.

TABLE 1
Comparison in Thermal Conductivity of Aerogels

| Solvent | Thermal Conductivity(mW/mK) |
|---|---|
| n-butanol | 12 |
| tert-butanol | 23 |
| Propanol | 44 |
| Hexane | 29 |
| Acetone | 53 |

As shown in the table 1, the aerogel prepared using n-butanol has lowest thermal conductivity among the aerogel prepared using various solvent. Thus, n-butanol is selected as a solvent for simultaneous step of silylation and solvent replacement.

### Example 2

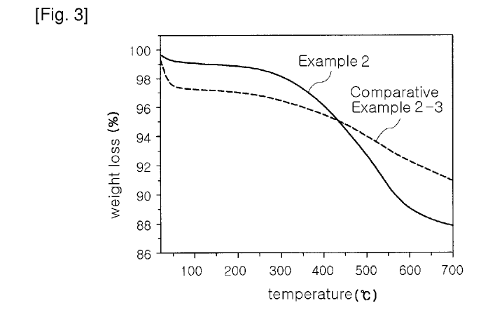

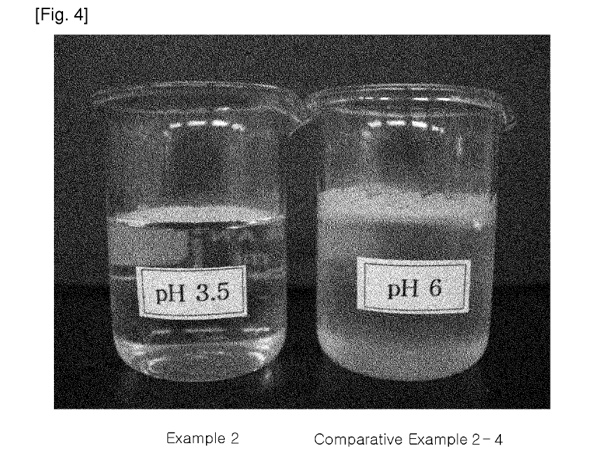

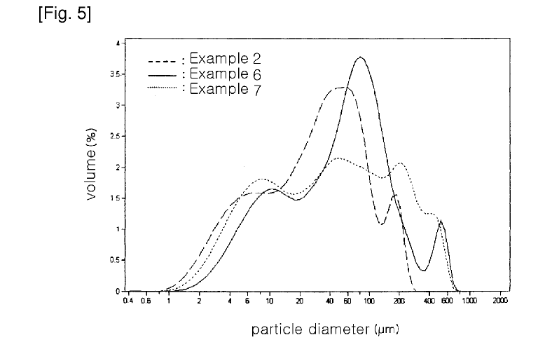

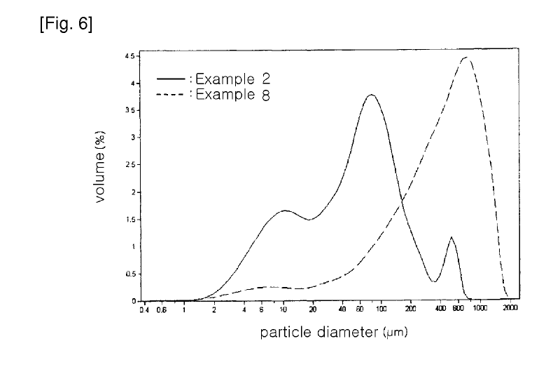

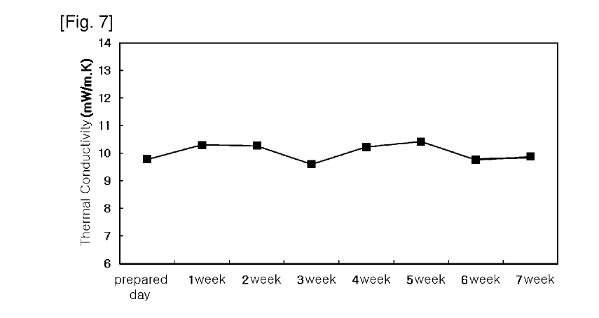

A water glass solution (a 3-fold dilution of a 35% sodium silicate solution in water (i.e. the ratio of a 35% sodium silicate solution and water (1:3, wt/wt)) was slowly added to 1 L of a 1N hydrochloric acid solution with stirring, to adjust pH of the water glass solution to 3.5. At this time, a reaction temperature was 80° C. The solution was further stirred for about 2 hours, while the pH of 3.5 was maintained, thereby preparing silica hydrogel. The hydrogel was put in a mixer, and was then washed with distilled water several times for 4 hours, to remove Na⁺ ions contained therein. The amount of Na⁺ ions in the washed hydrogel was 2,000 ppm The resulting silica hydrogel was simultaneously subjected to permanently hydrophobic treatment of the surface thereof with a silane compound and removal of water contained therein using n-butanol. The silica hydrogel was immersed in a silylating solution of 5 wt % ethyl trimethoxy silane (ETMS) in n-butanol under acidic conditions of pH 3.5 adjusted by hydrochloric acid, followed by refluxing at 120 to 150° C. for 4 hours. The resulting silica hydrogel was dried at 150° C. for 2 hours to remove the n-butanol from the surface thereof. The thermal conductivity (measured 1 week after the preparation) of aerogel powder prepared thus was 9 mW/m·K. Thermal gravimetric analysis (TGA) graphs illustrating variations in the content of the remaining solvent in aerogel powders prepared in Example 2 and Comparative Example 2-3 are shown in FIG. 3. From FIG. 3, it could be confirmed that solvent in the aerogel prepared in Example 2 is removed effectively than that of Comparative Example 2-3. From FIG. 4, it could be confirmed that aerogel prepared in Example 2 was not precipitated in water even for a long period of time, specifically even after 7 weeks and its state was maintained. In addition, distribution for the particle size of the aerogel is shown in FIGS. 5 and 6. Further, the variation of thermal conductivity of aerogels prepared in example 2 based on the elapsed time is showed in FIG. 7.

### Comparative Example 2-1

Aerogel was prepared in the same manner as in Example 2, except that mixer was not used upon washing of the hydrogel using distilled water. The amount of Na⁺ ions in the washed hydrogel was 6,000 ppm The thermal conductivity (measured 1 week after the preparation) of prepared aerogel powder was 18 mW/m·K.

### Comparative Example 2-2

Aerogel was prepared in the same manner as in Example 2, except that solvent replacement only was conducted with n-butanol without silylation with a silylating agent. The thermal conductivity of prepared aerogel powder was 23 mW/m·K.

### Comparative Example 2-3

Aerogel was prepared in the same manner as in Example 2, except that a silylating solution of 5 wt % ethyl trimethoxy silane (ETMS) in methanol was used instead of the silylating solution of 5 wt % ethyl trimethoxy silane (ETMS) in n-butanol. The thermal conductivity (measured 1 week after the preparation) of prepared aerogel powder was 48 mW/m·K.

### Comparative Example 2-4

Aerogel was prepared in the same manner as in Example 2, except that acidity was pH 6, instead of pH 3.5, when the hydrogel was immersed in a silylating solution of 5 wt % ethyl trimethoxy silane (ETMS) in n-butanol. The thermal conductivity (measured 1 week after the preparation) of prepared aerogel powder was 14 mW/m·K. In this Example, since the reaction is carried out at pH 6, the fine hydrogel remains unreacted with the silane compound. It can be confirmed from FIG. 4 that the unreacted gel was gradually precipitated in water for a long period for time, specifically even after 7 weeks.

### Comparative Example 2-5

Aerogel was prepared in the same manner as in Example 2, except that after the hydrogel was immersed in a silylating solution of 5 wt % ethyl trimethoxy silane (ETMS) in methanol under acid conditions of pH 3.5, followed by refluxing at 120 to 150° C. for 4 hours, the silylated hydrogel was again refluxed in a n-butanol solution at 120 to 150° C. for 4 hours, to remove water contained therein by solvent replacement. The thermal conductivity (measured 1 week after the preparation) of prepared aerogel powder was 15 mW/m·K.

TABLE 2
Comparison in Thermal Conductivity of Among Aerogel Powders

| | Thermal | Silane | |
|---|---|---|---|
| | conductivity | hydrophobizing | |
| | (mW/mK) | agent | Experiment Method |
| EX. 2 | 9 | ETMS* | Hydrogel preparation - Washing with |
| | | | mixer - Simultaneous treatment of |
| | | | silylating agent (pH = 3.5) and n-butanol |
| Comp. EX. | 18 | ETMS* | Hydrogel preparation - General washing - |
| 2-1 | | | Simultaneous treatment of silylating agent |
| | | | (pH = 3.5) and n-butanol |
| Comp. EX. | 23 | Not used | Hydrogel preparation - Washing with |
| 2-2 | | | mixer -n-butanol treatment (pH = 3.5) |
| Comp. EX. | 48 | ETMS* | Hydrogel preparation - Washing with |
| 2-3 | | | mixer - Simultaneous treatment of |
| | | | silylating agent (pH = 3.5) and methanol |
| Comp. EX. | 14 | ETMS* | Hydrogel preparation - Washing with |
| 2-4 | | | mixer - Simultaneous treatment of |
| | | | silylating agent (pH = 6) and n-butanol |
| Comp. EX. | 15 | ETMS* | Hydrogel preparation - Washing with mixer - |
| 2-5 | | | Silylating agent (pH = 3.5) - n-butanol |
| | | | treatment |

ETMS*: ethyl trimethoxy silane

### Example 3

Aerogel was prepared in the same manner as in Example 2, except that hexamethyl disilane (HMDS) was used as a silylating agent instead of ETMS. After drying at 150° C. for 2 hours, the thermal conductivity (measured 1 week after the preparation) of prepared aerogel powder was 8 mW/m·K.

### Comparative Example 3

Aerogel was prepared in the same manner as in Example 3, except that the hydrogel was dipped in a silylating solution of a silylating agent in methanol (MeOH) and refluxed at 120 to 150° C. for 4 hours to obtain a hydrogel whose surface is treated with silane groups, and the resulting hydrogel was again refluxed in a n-butanol at 120 to 150° C. for 4 hours to remove moisture from the hydrogel via solvent-replacement. The thermal conductivity (measured 1 week after the preparation) of aerogel powder prepared thus was 14 mW/m·K.

TABLE 3
Comparison in Thermal Conductivity Between Aerogel Powders

| | Thermal | Silane | |
|---|---|---|---|
| | conductivity | hydrophobizing | |
| | (mW/mK) | agent | Experiment Method |
| EX. 3 | 8 | HMDS* | Hydrogel preparation - Washing with |
| | | | mixer - Simultaneous treatment of |
| | | | silylating agent (pH = 3.5) and n-butanol |
| Comp. EX. | 14 | HMDS* | Hydrogel preparation - Washing with |
| 3 | | | mixer - n-butanol treatment after silylating |
| | | | agent treatment (pH = 3.5) |

HMDS*: hexamethyl disilane

### Example 4

Aerogel was prepared in the same manner as in Example 2, except that trimethoxy silane (TMS) was used as a silylating agent instead of ETMS. After drying at 150° C. for 2 hours, the thermal conductivity (measured 1 week after the preparation) of prepared aerogel powder was 10 mW/mK.

### Comparative Example 4

Aerogel was prepared in the same manner as in Example 4, except that the hydrogel was dipped in a silylating solution of a silylating agent in methanol (MeOH) and refluxed at 120 to 150° C. for 4 hours to obtain a hydrogel whose surface is treated with silane groups, and the resulting hydrogel was again refluxed in a n-butanol at 120 to 150° C. for 4 hours to remove moisture from the hydrogel via solvent-replacement. The thermal conductivity (measured 1 week after the preparation) of aerogel powder prepared thus was 18 mW/m·K.

TABLE 4
Comparison in Thermal Conductivity of Between Aerogel Powders

| | Thermal | Silane | |
|---|---|---|---|
| | conductivity | hydrophobizing | |
| | (mW/mK) | agent | Experiment Method |
| EX. 4 | 10 | TMS* | Hydrogel preparation - Washing with |
| | | | mixer - Simultaneous treatment of |
| | | | silylating agent (pH = 3.5) and n-butanol |
| Comp. EX. | 18 | TMS* | Hydrogel preparation - Washing with |
| 4 | | | mixer - n-butanol treatment after |
| | | | silylating agent treatment (pH = 3.5) |

TMS*: trimethoxy silane

### Example 5

Aerogel was prepared in the same manner as in Example 2, except that methoxy trimethyl silane (MTMS) was used as a silylating agent instead of ETMS. After drying at 150° C. for 2 hours, the thermal conductivity (measured 1 week after the preparation) of prepared aerogel powder was 11 mW/mK.

### Comparative Example 5

Aerogel was prepared in the same manner as in Example 5, except that the hydrogel was dipped in a silylating solution of a silylating agent in methanol (MeOH) and refluxed at 120 to 150° C. for 4 hours to obtain a hydrogel whose surface is treated with silane groups, and the resulting hydrogel was again refluxed in at 120 to 150° C. for 4 hours to remove moisture from the hydrogel via solvent-replacement. The thermal conductivity (measured 1 week after the preparation) of aerogel powder prepared thus was 23 mW/m·K.

TABLE 5
Comparison in Thermal Conductivity between Aerogel Powders

| | Thermal | Silane | |
|---|---|---|---|
| | conductivity | hydrophobilizing | |
| | (mW/mK) | agent | Experiment Method |
| EX. 5 | 11 | MTMS* | Hydrogel preparation - Washing with |
| | | | mixer - Simultaneous treatment of |
| | | | silylating agent (pH = 3.5) and n-butanol |
| Comp. EX. | 23 | MTMS* | Hydrogel preparation -Washing with |
| 5 | | | mixer - n-butanol treatment after |
| | | | silylating agent treatment (pH = 3.5) |

MTMS*: methoxy trimethyl silane

### Example 6

A water glass solution (a 0.5-fold dilution of a 35% sodium silicate solution in water) was slowly added to IL of a 1N hydrochloric acid solution with stirring, to adjust pH of the water glass solution to 3.5. At this time, a reaction temperature was 60° C. The solution was further stirred for about 2 hours, while the pH of 3.5 was maintained, thereby preparing silica hydrogel. The hydrogel was put in a mixer, and was then washed with distilled water several times for 4 hours, to remove Na ions contained therein. The resulting silica hydrogel was simultaneously subjected to permanently hydrophobic surface-treatment and removal of water contained therein using silylating solution. The simultaneous process is carried out by immersing the hydrogel in a silylating solution of 5 wt % ethyl trimethoxy silane (ETMS) in n-butanol under acidic conditions of pH 3.5 adjusted by hydrochloric acid, followed by refluxing at 120 to 150° C. for 4 hours. The resulting silica hydrogel was dried at 120° C. for 2 hours to remove the n-butanol from the surface thereof. The thermal conductivity and density (measured 1 week after the preparation, respectively) of aerogel powder prepared thus was 10 mW/m·K and 0.07 g/cc, respectively. In addition, distribution for the particle size of the aerogel powder is shown in FIG. 5.

### Example 7

A water glass solution (a 6-fold dilution of a 35% sodium silicate solution in water) was slowly added to IL of a 1N hydrochloric acid solution with stirring, to adjust pH of the water glass solution to 3.5. At this time, a reaction temperature was 60° C. The solution was further stirred for about 2 hours, while the pH of 3.5 was maintained, thereby preparing silica hydrogel. The hydrogel was put in a mixer, and was then washed with distilled water several times for 4 hours, to remove Na ions contained therein. The resulting silica hydrogel was simultaneously subjected to permanently hydrophobic surface-treatment and removal of water contained therein using a silylating solution. The simultaneous process is carried out by immersing the hydrogel in a silylating solution of 5 wt % ethyl trimethoxy silane (ETMS) in n-butanol under acidic conditions of pH 3.5 adjusted by hydrochloric acid, followed by refluxing at 120 to 150° C. for 4 hours. The resulting silica hydrogel was dried at 120° C. for 2 hours to remove the n-butanol from the surface thereof. The thermal conductivity and density (measured 1 week after the preparation, respectively) of aerogel powder prepared thus was 12 mW/m·K and 0.009 g/cc, respectively. In addition, distribution for the particle size of the aerogel powder is shown in FIG. 5.

### Example 8

3% by weight of fumed silica (diameter: about 0.5 μm), based on the weight of water glass, and a water glass solution (a 3-fold dilution of a 35% sodium silicate solution in water) were slowly added to IL of a 1N hydrochloric acid solution with stirring, to adjust pH of the water glass solution to 3.5. At this time, a reaction temperature was 60° C. The solution was further stirred for about 2 hours, while the pH of 3.5 was maintained, thereby preparing silica hydrogel. The hydrogel was put in a mixer, and was then washed with distilled water several times for 4 hours, to remove Na ions contained therein. The resulting silica hydrogel was simultaneously subjected to permanently hydrophobic surface-treatment and removal of water contained therein using a silylating solution. The simultaneous process is carried out by immersing the hydrogel in a silylating solution of 5 wt % ethyl trimethoxy silane (ETMS) in n-butanol under acidic conditions of pH 3.5 adjusted by hydrochloric acid, followed by refluxing at 120 to 150° C. for 4 hours. The resulting silica hydrogel was dried at 120° C. for 2 hours to remove the n-butanol from the surface thereof. The thermal conductivity and density (measured 1 week after the preparation, respectively) of aerogel powder prepared thus was 12 mW/m·K and 0.12 g/cc, respectively. In addition, distribution for the particle size of the aerogel powder is shown in FIG. 6.

### Example 9

% by weight of fumed silica (diameter: about 400 μm), based on the weight of water glass, and a water glass solution (a 3-fold dilution of a 35% sodium silicate solution in water) were slowly added to IL of a 1N hydrochloric acid solution with stirring, to adjust pH of the water glass solution to 3.5. At this time, a reaction temperature was 60° C. The solution was further stirred for about 2 hours, while the pH of 3.5 was maintained, thereby preparing silica hydrogel. The hydrogel was put in a mixer, and was then washed with distilled water several times for 4 hours, to remove Na ions contained therein. The resulting silica hydrogel was simultaneously subjected to permanently hydrophobic surface-treatment and removal of water contained therein using a silylating solution. The simultaneous process is carried out by immersing the hydrogel in a silylating solution of 5 wt % ethyl trimethoxy silane (ETMS) in n-butanol under acidic conditions of pH 3.5 adjusted by hydrochloric acid, followed by refluxing at 120 to 150° C. for 4 hours. The resulting silica hydrogel was dried at 120° C. for 2 hours to remove the n-butanol from the surface thereof. The thermal conductivity, density, and average diameter (measured 1 week after the preparation, respectively) of aerogel powder prepared thus was 14 mW/m·K, 0.14 g/cc, and about 600 μm, respectively.

### INDUSTRIAL APPLICABILITY

As apparent from the above description, according to the present invention, permanently hydrophobic porous aerogel can be prepared by silylation of aerogel surface. Since the aerogel has a hydrophobic surface, it does not react with moisture in the air. Accordingly, aerogel is suitable for use in additives for rubbers, plastics, papers, etc. The method of the present invention uses a one-step procedure (i.e., simultaneous treatment of silylation and solvent replacement), thereby ensuring simplification, as compared to conventional methods comprising multi-step solvent replacement before and after silylation, and residue removal after the silylation.

In addition, although a silane compound having a low concentration is used, it is possible to realize a thermal conductivity comparable to conventional aerogel powders. Silylation under strong acid conditions is conducted without leaving any residue behind, thereby obtaining permanently hydrophobic aerogel. The silylating agent is used in a small amount, thus making it possible to ensure low costs and mass-production.

Furthermore, the method of the present invention enables preparation of porous aerogel which has an increased diameter and density and is permanently hydrophobically modified via surface-silylation. In addition, this aerogel exhibits superior mechanical properties e.g. strength. Accordingly, the aerogel has improved miscibility with other materials and avoids problems (e.g. variation in composition) due to scattering, thus being efficiently utilized in various processes.

1. A method for preparing permanently hydrophobic aerogel comprising:
adding sodium silicate to HCl at 30 to 90° C. until an acidity reaches pH 3-5, to form silica hydrogel under acidic conditions of pH 3-5;
washing the silica hydrogel with distilled water using a mixer, followed by filtering;
adding the silica hydrogel to a silylating solution of silylating agent in n-butanol at pH 1-5 using an acid selected from hydrochloric acid, sulfuric acid, phosphoric acid and nitric acid, to simultaneously conduct silylation and solvent replacement; and
drying the silica hydrogel.

2. The method according to claim 1, wherein seed particles are further added during forming the silica hydrogel.

3. The method according to claim 2, wherein the seed particles are at least one selected from the group consisting of fumed silica, TiO₂, Fe₂O₃ and Al₂O₃.

4. The method according to claim 2, wherein the seed particles are added in an amount of 0.5 to 20% by weight, based on the weight of the sodium silicate.

5. The method according to claim 2, wherein the seed particles have a size of 0.1 to 500 μm.

6. The method according to claim 1, further comprising aging the silica hydrogel after forming the silica hydrogel.

7. The method according to claim 6, wherein the aging is conducted at 20 to 80° C. for 2 to 24 hours.

8. The method according to claim 1, wherein the silylation is conducted using a silylating agent selected from the group consisting of Formula 1 and 2 below:
(R₁)₄₋ₙSiXₙ (1)
wherein n is 1 to 3; R₁ is a C₁-C₁₀ alkyl group, C₆ aromatic group (wherein the aromatic group can be substituted with C₁-C₂ alkyl group), a C₅ heteroaromatic group (wherein the heteroaromatic group can be substituted with C₁-C₂ alkyl group), or hydrogen; X is a halogen atom selected from F, Cl, Br and I, a C₁-C₁₀ alkoxy group, a C₆ aromatic group (wherein the aromatic group can be substituted with C₁-C₂ alkoxy group) or C₅ heteroaromatic group (wherein the heteroaromatic group can be substituted with C₁-C₂ alkoxy group), and
R₃Si—O—SiR₃ (2)
wherein each R₃ is same or different; and R₃ is a C₁-C₁₀ alkyl group, a C₆ aromatic group (wherein the aromatic group can be substituted with C₁-C₂ alkyl group), a C₅ heteroaromatic group (wherein the heteroaromatic group can be substituted with C₁-C₂ alkyl group), or hydrogen.

9. The method according to claim 8, wherein the silylating agent is at least one selected from the group consisting of hexamethyldisilane, trimethoxysilane, ethyltriethxoysilane, triethylethoxysilane, methyltrimethoxysilane, ethyltrimethoxysilane, methoxytrimethylsilane, trimethylchlorosilane and tri-ethylchlorosilane.

10. The method according to claim 1, wherein the silylating solution of a silylating agent in n-butanol is a solution of 1 to 10% by weight of the silylating agent and 90 to 99% by weight of n-butanol.

11. The method according to claim 1, wherein the drying is conducted at a temperature of from 100 to 250° C.

12. The method according to claim 1, wherein the n-butanol used in the silylation and the solvent-replacement processes is distilled and is then recycled in the processes.

13. Permanently hydrophobic aerogel prepared by the method according to claim 1.

14. The method according to claim 2, further comprising aging the silica hydrogel after forming the silica hydrogel.

15. The method according to claim 2, wherein the n-butanol used in the silylation and the solvent-replacement processes is distilled and is then recycled in the processes.

16. The method according to claim 2, wherein the silylation is conducted using a silylating agent selected from the group consisting of Formulas 1 and 2 below:
(R₁)₄₋ₙSiXₙ (1)
wherein n is 1 to 3; R₁ is a C₁-C₁₀ alkyl group, C₆ aromatic group (wherein the aromatic group can be substituted with C₁-C₂ alkyl group), a C₅ heteroaromatic group (wherein the heteroaromatic group can be substituted with C₁-C₂ alkyl group), or hydrogen; X is a halogen atom selected from F, Cl, Br and I, a C₁-C₁₀ alkoxy group, a C₆ aromatic group (wherein the aromatic group can be substituted with C₁-C₂ alkoxy group) or C₅ heteroaromatic group (wherein the heteroaromatic group can be substituted with C₁-C₂ alkoxy group), and
R₃Si—O—SiR₃ (2)
wherein each R₃ is same or different; and R₃ is a C₁-C₁₀ alkyl group, a C₆ aromatic group (wherein the aromatic group can be substituted with C₁-C₂ alkyl group), a C₅ heteroaromatic group (wherein the heteroaromatic group can be substituted with C₁-C₂ alkyl group), or hydrogen.

17. Permanently hydrophobic aerogel prepared by the method according to claim 2.

18. Permanently hydrophobic aerogel prepared by the method according to claim 6.

19. Permanently hydrophobic aerogel prepared by the method according to claim 8.

20. Permanently hydrophobic aerogel prepared by the method according to claim 12.
